(19) United States
(12) Patent Application Publication
(10) Pub. No.: US 2016/0280072 A1
(43) Pub. Date: Sep. 29, 2016

(54) CONTROL DEVICE FOR VEHICLE

(71) Applicant: TOYOTA JIDOSHA KABUSHIKI KAISHA, Toyota-shi, Aichi-ken (JP)

(72) Inventors: Masaki OKAMURA, Toyota-shi, Aichi-ken (JP); Sintaro TSUJII, Chiryu-shi, Aichi-ken (JP); Wanleng ANG, Gotemba-shi, Shizuoka-ken (JP); Yoshitaka NIIMI, Susono-shi, Shizuoka-ken (JP); Hideaki YAGUCHI, Toyota-shi, Aichi-ken (JP); Keisuke MORISAKI, Toyota-shi, Aichi-ken (JP)

(73) Assignee: TOYOTA JIDOSHA KABUSHIKI KAISHA, Toyota-shi, Aichi-ken (JP)

(21) Appl. No.: 15/031,371

(22) PCT Filed: Oct. 24, 2014
(86) PCT No.: PCT/IB2014/002220

§ 371 Date: Apr. 22, 2016

(30) Foreign Application Priority Data
Oct. 24, 2013 (JP) 2013-221092

(51) Int. Cl. B60L 7/00; B60L 3/12; H02P 6/24; H02P 29/00; H02P 3/02

(52) U.S. Cl. CPC B60L 7/003; H02P 29/0066; H02P 3/025; H02P 6/24; B60L 3/12; Y02T 10/642; B60L 2240/425; B60L 2260/30

(57) ABSTRACT

A control device for a vehicle is equipped with second determination means for determining that the vehicle is stopped when first determination means determines that a rotational speed of a three-phase alternating-current electric motor is equal to or lower than a predetermined threshold and that a stop operation is performed, control means for controlling an electric power converter such that a state of the electric power converter becomes a specific state where i) all the first switching are off and at least one of the second switching elements is on or ii) all the second switching elements are off and at least one of the first elements is on, and threshold setting means for setting the predetermined threshold based on a temperature of a magnet of the three-phase alternating-current electric motor.

### BACKGROUND OF THE INVENTION

1. Field of the Invention

The invention relates to, for example, the technical field of a control device that controls a vehicle that is equipped with an electric motor.

2. Description of Related Art

In recent years, vehicles that are equipped with electric motors (so-called motors) have been drawing attention. As an example of vehicles that are equipped with such electric motors, there is known a hybrid vehicle that is equipped with both an electric motor and an internal combustion engine (e.g., see Japanese Patent Application Publication No. 2006-288051 (JP-2006-288051 A)).

In Japanese Patent Application Publication No. 2006-288051 (JP-2006-288051 A), there is disclosed an art in which three-phase short-circuit control of an electric motor is performed to stop an internal combustion engine from rotating at an early stage when the rotational speed of the internal combustion engine is lower than a predetermined rotational speed in such a hybrid vehicle.

### SUMMARY OF THE INVENTION

By the way, when three-phase short-circuit control is performed, a drag torque is generated in the electric motor and may constitute a cause of vibration of the vehicle. This drag torque changes depending on the counter electromotive voltage of the electric motor (specifically, the drag torque of the electric motor increases as the counter electromotive voltage increases). Besides, the counter electromotive voltage of the electric motor changes depending on the temperature of a magnet of the electric motor (specifically, the counter electromotive voltage of the electric motor drops as the magnet temperature rises).

It should be noted herein that the studies conducted by the inventor of the present application have revealed that the rotational speed of the electric motor can be utilized as a condition for starting three-phase short-circuit control of the electric motor (i.e., the rotational speed of the electric motor can be utilized instead of the rotational speed of the internal combustion engine in Japanese Patent Application Publication No. 2006-288051 (JP-2006-288051 A)). However, if a predetermined threshold for the rotational speed of the electric motor is made constant, there arises a technical problem in that it is difficult to avoid inconveniences resulting from the aforementioned drag torque and the like.

More specifically, if the predetermined threshold is set as, for example, a relatively high constant value, three-phase short-circuit control is performed even in the case where the rotational speed of the electric motor is relatively high. Therefore, when the temperature of the magnet of the electric motor is low, a large drag torque is generated, so a deterioration in drivability is caused.

The invention provides a control device for a vehicle that makes it possible to appropriately change a threshold about a determination on stoppage of the vehicle and favorably perform stop control.

A control device according to one aspect of the invention is designed for a vehicle. The vehicle includes a three-phase alternating-current electric motor and an electric power converter. The three-phase alternating-current electric motor is driven at a rotational speed synchronized with a rotational speed of a drive shaft of the vehicle. The three-phase alternating-current electric motor is provided with first switching elements and second switching elements in three phases of the three-phase alternating-current electric motor respectively, and the first switching elements and the second switching elements are connected in series to each other respectively. The electric power converter converts an electric power supplied to the three-phase alternating-current electric motor from a direct-current electric power into an alternating-current electric power. The control device includes an electronic control unit configured to a) determine whether or not a rotational speed of the three-phase alternating-current electric motor is equal to or lower than a predetermined rotational speed, b) determine whether or not a stop operation to stop the vehicle is performed, c) determine that the vehicle is stopped, when the electronic control unit determines that the rotational speed of the three-phase alternating-current electric motor is equal to or lower than the predetermined rotational speed and the stop operation is performed, d) control the electric power converter such that a state of the electric power converter becomes a specific state when the electronic control unit determines that the vehicle is stopped, the specific state being a state where i) all the first switching are off and at least one of the second switching elements is on or ii) all the second switching elements are off and at least one of the first elements is on, and e) set the predetermined rotational speed based on a temperature of a magnet of the three-phase alternating-current electric motor.

The control device according to the aspect of the invention makes it possible to control the vehicle that is equipped with the three-phase alternating-current electric motor. The three-phase alternating-current electric motor is installed in the vehicle such that the rotational speed of the three-phase alternating-current electric motor is synchronized with the rotational speed of the drive shaft of the vehicle. In this case, “the state where the rotational speed of the three-phase alternating-current electric motor is synchronized with the rotational speed of the drive shaft” means a state where the rotational speed of the three-phase alternating-current electric motor and the rotational speed of the drive shaft are correlated with each other. Typically, “the state where the rotational speed of the three-phase alternating-current electric motor is synchronized with the rotational speed of the drive shaft” is a state where the rotational speed of the three-phase alternating-current electric motor is proportional to the rotational speed of the drive shaft (i.e., the state where the rotational speed of the three-phase alternating-current electric motor×K (it should be noted, however, that K is an arbitrary constant)=the rotational speed of the drive shaft). “The state where the rotational speed of the three-phase alternating-current electric motor is synchronized with the rotational speed of the drive shaft” may be realized by directly coupling a rotary shaft of the three-phase alternating-current electric motor to the drive shaft. Alternatively, “the state where the rotational speed of the three-phase alternating-current electric motor is synchronized with the rotational speed of the drive shaft” may be realized by indirectly coupling the rotary shaft of the three-phase alternating-current electric motor to the drive shaft via some mechanical mechanism (e.g., a reduction gear mechanism).

Besides, the three-phase alternating-current electric motor is driven through the use of an electric power supplied from the electric power converter (i.e., an alternating-current electric power). In order to supply an electric power to the three-phase alternating-current electric motor, the electric power converter is equipped with first switching elements (e.g., switching elements that are electrically connected between a high voltage-side terminal of an electric power supply and the three-phase alternating-current electric motor) and second switching elements (e.g., switching elements that are electrically connected between a low voltage-side terminal of the electric power supply and the three-phase alternating-current electric motor) that are connected in series to each other respectively, in three phases thereof respectively. That is, the electric power converter is equipped with the first switching element and the second switching element that are arranged in a U-phase, the first switching element and the second switching element that are arranged in a V-phase, and the first switching element and the second switching element that are arranged in a W-phase.

In the aspect of the invention, the control device is equipped with first determination means and second determination means to determine whether or not the vehicle that is equipped with the three-phase alternating-current electric motor is stopped.

The first determination means performs a determination operation based on the rotational speed of the three-phase alternating-current electric motor. Specifically, the first determination means determines whether or not the rotational speed of the three-phase alternating-current electric motor is equal to or lower than a predetermined rotational speed. In addition, the first determination means performs a determination operation based on the presence/absence of a stop operation capable of stopping the vehicle. Specifically, the first determination means determines whether or not the stop operation capable of stopping the vehicle is performed.

The second determination means determines, based on a determination result of the first determination means, whether or not the vehicle is stopped. Specifically, the second determination means determines that the vehicle is stopped, when the first determination means determines that the rotational speed of the three-phase alternating-current electric motor is equal to or lower than the predetermined rotational speed and that the stop operation is performed. On the other hand, the second determination means may determine that the vehicle is not stopped, when the first determination means determines that the rotational speed of the three-phase alternating-current electric motor is not equal to or lower than the predetermined rotational speed. By the same token, the second determination means may determine that the vehicle is not stopped, when the first determination means determines that the stop operation is not performed.

The aforementioned first determination means and the aforementioned second determination means make it possible to determine whether or not the vehicle is stopped, based on the presence/absence of the stop operation as well as the rotational speed of the three-phase alternating-current electric motor. Therefore, the control device for the vehicle according to the invention can more accurately determine whether or not the vehicle is stopped, than a control device for a vehicle according to a first comparative example which determines that the vehicle is stopped when the rotational speed of an internal combustion engine at which the detection accuracy can be lower than the accuracy in detecting the rotational speed of the three-phase alternating-current electric motor is equal to or lower than a predetermined threshold. In addition, the control device for the vehicle according to the invention can more accurately determine whether or not the vehicle is stopped, than a control device for a vehicle according to a second comparative example which determines that the vehicle is stopped when the rotational speed of the three-phase alternating-current electric motor is equal to or lower than a predetermined rotational speed without determining whether or not a stop operation is performed.

Incidentally, the second determination means may determine whether or not the vehicle is stopped, based on a duration time of a state where the first determination means determines that the rotational speed of the three-phase alternating-current electric motor is equal to or lower than the predetermined rotational speed and that the stop operation is performed. That is, the second determination means may determine that the vehicle is stopped, when the aforementioned duration time is equal to or longer than a predetermined period. On the other hand, the second determination means preferably determines that the vehicle is not stopped, when the aforementioned duration time is not equal to or longer than the predetermined period. According to this determination, the second determination means can more accurately determine whether or not the vehicle is stopped. In particular, even in the case where, for example, a hunting of the rotational speed of the three-phase alternating-current electric motor occurs (or the rotational speed of the three-phase alternating-current electric motor fluctuates), the second determination means can more accurately determine whether or not the vehicle is stopped.

Besides, in the aspect of the invention, the control device is equipped with control means for controlling the electric power converter. The control means controls the electric power converter such that the state of the electric power converter becomes a specific state (typically, remains fixed to the specific state) when the second determination means determines that the vehicle is stopped. It should be noted herein that “the specific state” is a state where either the first switching elements or the second switching elements are all off (i.e., a disconnected state) and at least one of the other ones of the first switching elements and the second switching elements is on (i.e., a connected state). By holding the electric power converter in the specific state, a braking force is generated in the three-phase alternating-current electric motor. As a result, for example, stop control of the vehicle can be favorably performed. Incidentally, in a vehicle that is equipped with an additional three-phase alternating-current electric motor as well as the three-phase alternating-current electric motor according to the invention, an electric power converter corresponding to the additional three-phase alternating-current electric motor may also be controlled to assume the specific state. The control of holding the state of the aforementioned electric power converter identical to the specific state may be referred to hereinafter as “three-phase short-circuit control”.

It should be noted herein that an electric power needed for the running of the vehicle may not be supplied from the electric power converter to the three-phase alternating-current electric motor in the case where the state of the electric power converter is the specific state. Thus, in the invention, the electric power converter is controlled such that the state of the electric power converter becomes the specific state when the second determination means determines that the vehicle is stopped. In particular, the second determination means can accurately determine whether or not the vehicle is stopped as described above, so the control means can control the electric power converter such that the state of the electric power converter becomes the specific state exactly when the vehicle is stopped. That is, the control means can control the electric power converter such that the state of the electric power converter becomes the specific state at a timing when the running of the vehicle is not affected.

Furthermore, in the aspect of the invention, the control device is equipped with threshold setting means capable of changing the predetermined rotational speed that is utilized for a determination by the first determination means. The threshold setting means sets the predetermined rotational speed based on a temperature of a magnet of the three-phase alternating-current electric motor. When the predetermined rotational speed is thus set, the ease with which three-phase short-circuit control is performed is changed in accordance with the temperature of the magnet of the three-phase alternating-current electric motor. Incidentally, an upper limit and a lower limit may be set for the predetermined rotational speed.

It should be noted herein that if the predetermined rotational speed is a fixed value, various inconveniences may be caused in terms of practice. Specifically, for example, when a predetermined threshold is set as a relatively high fixed value, three-phase short-circuit control is performed even in the case where the rotational speed of the three-phase alternating-current electric motor is relatively high. Therefore, a large drag torque is generated in the case where the temperature of the magnet of the electric motor is low, so a deterioration in drivability may be caused.

Thus, in the aspect of the invention, as described above, the predetermined rotational speed is set in accordance with the temperature of the magnet of the three-phase alternating-current electric motor. In consequence, under a circumstance where, for example, the temperature of the magnet of the three-phase alternating-current electric motor is low and a large drag torque may be generated, the predetermined threshold is set small, so three-phase short-circuit control can be made unlikely to be performed.

As described above, according to the control device in the aspect of the invention, the predetermined threshold used to make a determination on stoppage of the vehicle is appropriately changed in accordance with the state of the three-phase alternating-current electric motor. Therefore, stop control can be favorably performed.

In the aforementioned aspect of the invention, the electronic control unit may be configured to set the predetermined rotational speed such that the predetermined rotational speed increases as the temperature of the magnet of the three-phase alternating-current electric motor rises.

According to this aspect of the invention, when the temperature of the magnet of the three-phase alternating-current electric motor is relatively high, the predetermined rotational speed is set as a relatively large value. Thus, under a circumstance where the temperature of the magnet is relatively high and a large drag torque is unlikely to be generated, three-phase short-circuit control is likely to be performed. In consequence, the effect of improving fuel economy through three-phase short-circuit control can be enhanced.

On the other hand, when the temperature of the magnet of the three-phase alternating-current electric motor is relatively low, the predetermined rotational speed is set as a relatively small value. Thus, under a circumstance where the temperature of the magnet is relatively low and a large drag is likely to be generated, three-phase short-circuit control is unlikely to be performed. In consequence, a deterioration in driveability can be favorably prevented from being caused as a result of the drag torque.

More specifically, the threshold setting means according to the present aspect of the invention sets the predetermined rotational speed as, for example, a value that is proportional to the temperature of the magnet of the three-phase alternating-current electric motor. In this manner, the predetermined rotational speed can be easily set as an appropriate value. It should be noted, however, that as long as the predetermined rotational speed monotonically increases with respect to the temperature of the magnet of the three-phase alternating-current electric motor, the aforementioned effect is exerted correspondingly.

In the aforementioned aspect of the invention, the electronic control unit may be configured to set the predetermined rotational speed such that the drag torque in the three-phase alternating-current electric motor becomes equal to or smaller than a predetermined value regardless of the temperature of the magnet of the three-phase alternating-current electric motor. In the aforementioned aspect of the invention, the electronic control unit may be configured to set the predetermined rotational speed such that a counter electromotive voltage in the three-phase alternating-current electric motor becomes equal to or lower than a predetermined value regardless of the temperature of the magnet of the three-phase alternating-current electric motor.

According to this aspect of the invention, by setting the predetermined rotational speed, the drag torque or the counter electromotive voltage in the three-phase alternating-current electric motor becomes equal to or smaller/lower than the predetermined value regardless of the temperature of the magnet of the three-phase alternating-current electric motor. In other words, even in the case where the temperature of the magnet of the three-phase alternating-current electric motor has fluctuated, the drag torque or the counter electromotive voltage in the three-phase alternating-current electric motor does not exceed the predetermined value. In consequence, inconveniences such as vibration of the vehicle and the like resulting from an increase in the drag torque or the counter electromotive voltage can be reliably avoided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing the configuration of a vehicle according to the first embodiment of the invention;

FIG. 2 is a flowchart showing the flow of a stop determination operation in the first embodiment of the invention;

FIG. 3 includes timing charts showing a rotational speed, a brake depression force value, the presence/absence of fulfillment of a stop determination condition, and a result of a determination on stoppage of the vehicle;

FIG. 4 includes graphs showing a method of setting a threshold in the first embodiment of the invention, in conjunction with a counter electromotive voltage and a drag torque of a motor-generator MG2 during three-phase short-circuit control;

FIG. 5 includes graphs showing a method of setting a threshold in a first comparative example, in conjunction with the counter electromotive voltage and the drag torque of the motor-generator MG2 during three-phase short-circuit control;

FIG. 6 includes graphs showing a method of setting a threshold in a modification example, in conjunction with the counter electromotive voltage and the drag torque of the motor-generator MG2 during three-phase short-circuit control;

FIG. 7 is a block diagram showing the configuration of a vehicle according to the second embodiment of the invention; and

FIG. 8 is a flowchart showing the flow of a stop determination operation in the second embodiment of the invention.

### DETAILED DESCRIPTION OF EMBODIMENTS

The embodiments of a control device for a vehicle will be described hereinafter.

### (1) First Embodiment

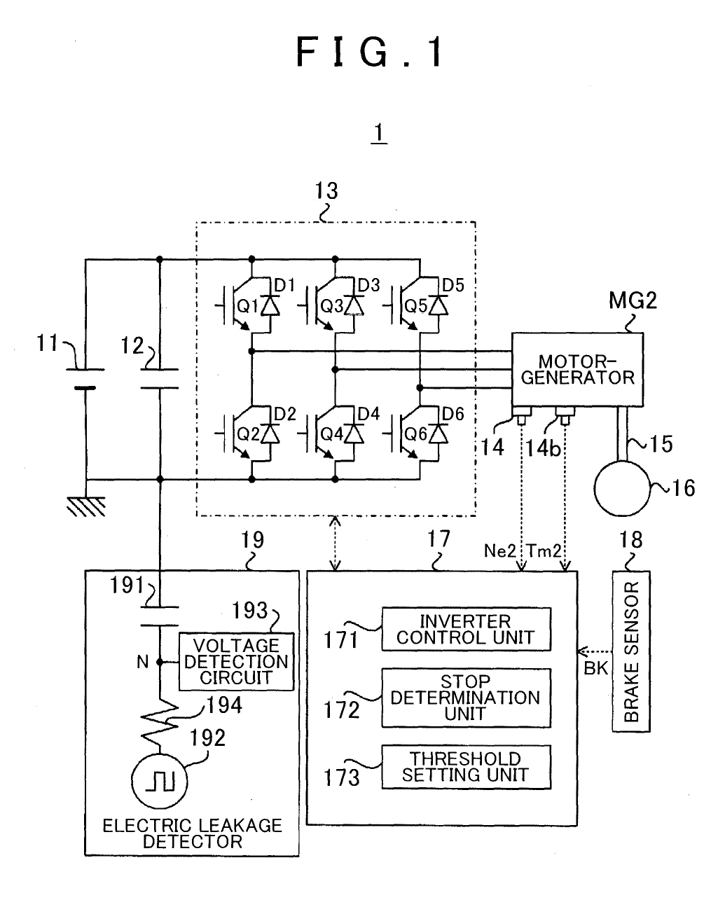

First of all, the first embodiment of the invention will be described with reference to FIGS. 1 to 6.

(1-1) Configuration of Vehicle According to First Embodiment

First of all, the configuration of a vehicle 1 according to the first embodiment of the invention will be described with reference to FIG. 1. FIG. 1 is a block diagram showing the configuration of the vehicle 1 according to the first embodiment of the invention.

As shown in FIG. 1, the vehicle 1 is equipped with a direct-current electric power supply 11, a smoothing capacitor 12, an inverter 13 as a concrete example of “the electric power converter”, a motor-generator MG2 as a concrete example of “the three-phase alternating-current electric motor”, a rotational angle sensor 14, a temperature sensor 14b, a drive shaft 15, a driving wheel 16, an electronic control unit (an ECU) 17 as a concrete example of “the control device for the vehicle”, a brake sensor 18, and an electric leakage detector 19.

The direct-current electric power supply 11 is a rechargeable electrical storage device. As an example of the direct-current electric power supply 11, for instance, a secondary battery (e.g., a nickel hydride battery, a lithium-ion battery or the like) or a capacitor (e.g., an electric double layer capacitor, a large-capacity capacitor or the like) is exemplified.

The smoothing capacitor 12 is a voltage smoothing capacitor that is connected between an anode line of the direct-current electric power supply 11 and a cathode line of the direct-current electric power supply 11.

The inverter 13 converts a direct-current electric power (a direct-current voltage) supplied from the direct-current electric power supply 11 into an alternating-current electric power (a three-phase alternating-current voltage). In order to convert the direct-current electric power (the direct-current voltage) into the alternating-current electric power (the three-phase alternating-current voltage), the inverter 13 is equipped with a U-phase arm that includes a p-side switching element Q1 and an n-side switching element Q2, a V-phase arm that includes a p-side switching element Q3 and an n-side switching element Q4, and a W-phase arm that includes a p-side switching element Q5 and an n-side switching element Q6. The respective arms with which the inverter 13 is equipped are connected in parallel between the anode line and the cathode line. The p-side switching element Q1 and the n-side switching element Q2 are connected in series between the anode line and the cathode line. The same holds true for the p-side switching element Q3 and the n-side switching element Q4, and the p-side switching element Q5 and the n-side switching element Q6. A rectifier diode D1 that causes a current to flow from an emitter terminal of the p-side switching element Q1 to a collector terminal of the p-side switching element Q1 is connected to the p-side switching element Q1. By the same token, rectifier diodes D2 to D6 are connected to the n-side switching elements Q2 to Q6 respectively. Intermediate points between upper ones of the respective phase arms in the inverter 13 (i.e., the respective p-side switching elements) and lower ones of the respective phase arms in the inverter 13 (i.e., the respective n-side switching elements) are connected to the respective phase coils of the motor-generator MG2. As a result, an alternating-current electric power (a three-phase alternating-current voltage) that is generated as a result of conversion operation by the inverter 13 is supplied to the motor-generator MG2.

The motor-generator MG2 is a three-phase alternating-current electric power generator. The motor-generator MG2 is driven in such a manner as to generate a torque needed for the running of the vehicle 1. The torque generated by the motor-generator MG2 is transmitted to the driving wheel 16 via the drive shaft 15 that is mechanically coupled to a rotary shaft of the motor-generator MG2. Incidentally, the motor-generator MG2 may regenerate an electric power (generate an electric power) during braking of the vehicle 1.

The rotational angle sensor 14 detects a rotational angle θ2 and a rotational speed Ne2 of the motor-generator MG2 (i.e., a rotational angle and a rotational speed of the rotary shaft of the motor-generator MG2). Preferably, the rotational angle sensor 14 directly detects the rotational angle θ2 and the rotational speed Ne2 of the motor-generator MG2. As an example of this rotational angle sensor 14, for example, a resolver such as a rotary encoder or the like is exemplified. The rotational angle sensor 14 preferably outputs the detected rotational angle θ2 and the detected rotational speed Ne2 to the ECU 17.

The temperature sensor 14b detects a temperature Tm2 of the magnet of the motor-generator MG2. Preferably, the temperature sensor 14b directly detects the temperature Tm2 of the magnet of the motor-generator MG2. It should be noted, however, that the temperature sensor 14b may indirectly detect (in other words, estimate) the temperature Tm2 of the magnet of the motor-generator MG2 from a temperature or the like of another region. The temperature sensor 14b preferably outputs the detected temperature Tm2 to the ECU 17.

The ECU 17 is an electronic control unit for controlling the operation of the vehicle 1. The ECU 17 according to this embodiment of the invention is equipped with an inverter control unit 171 as a concrete example of “the control means”, a stop determination unit 172 as a concrete example of “the first determination means” and “the second determination means”, and a threshold setting unit 173 as a concrete example of “the threshold setting means”, as physical, logical or functional processing blocks.

The inverter control unit 171 is a processing block for controlling the operation of the inverter 13. The inverter control unit 171 may control the operation of the inverter 13 through the use of a known control method. For example, the inverter control unit 171 may control the operation of the inverter 13 through the use of a pulse width modulation (PWM) control method.

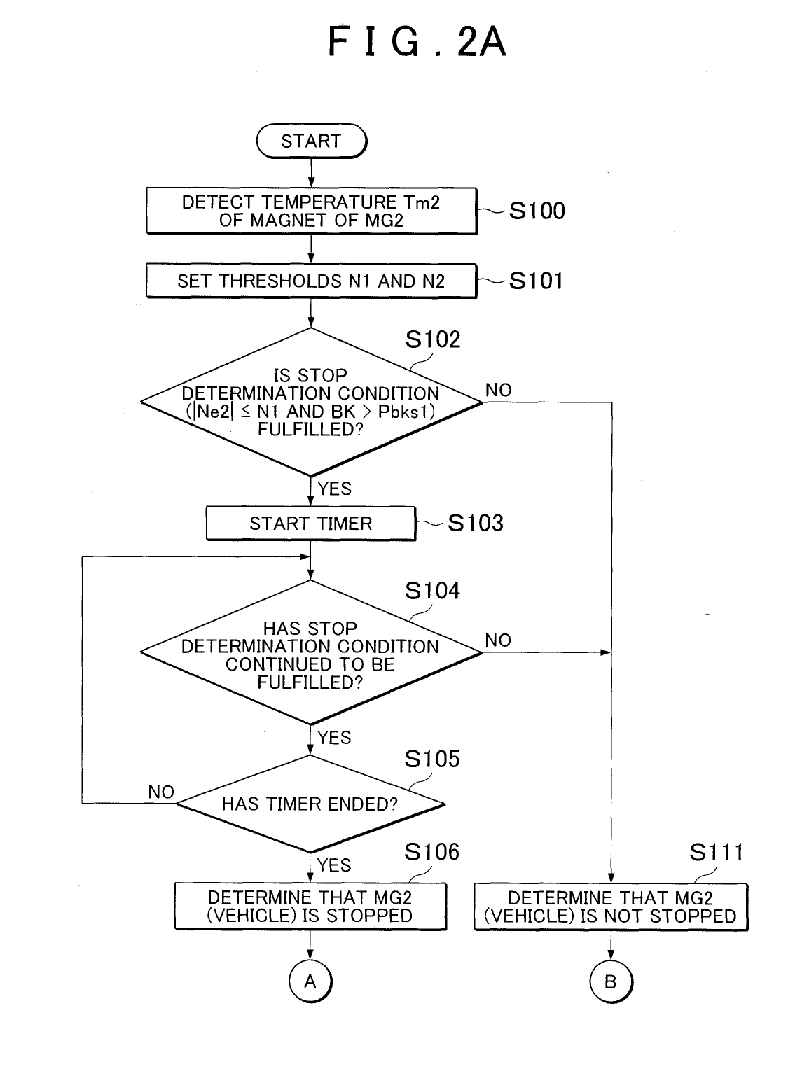

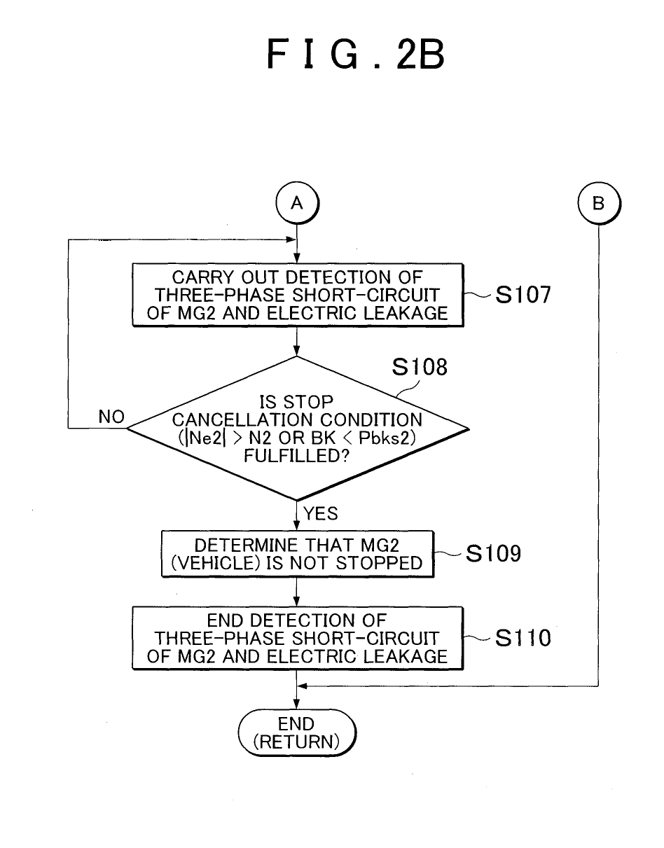

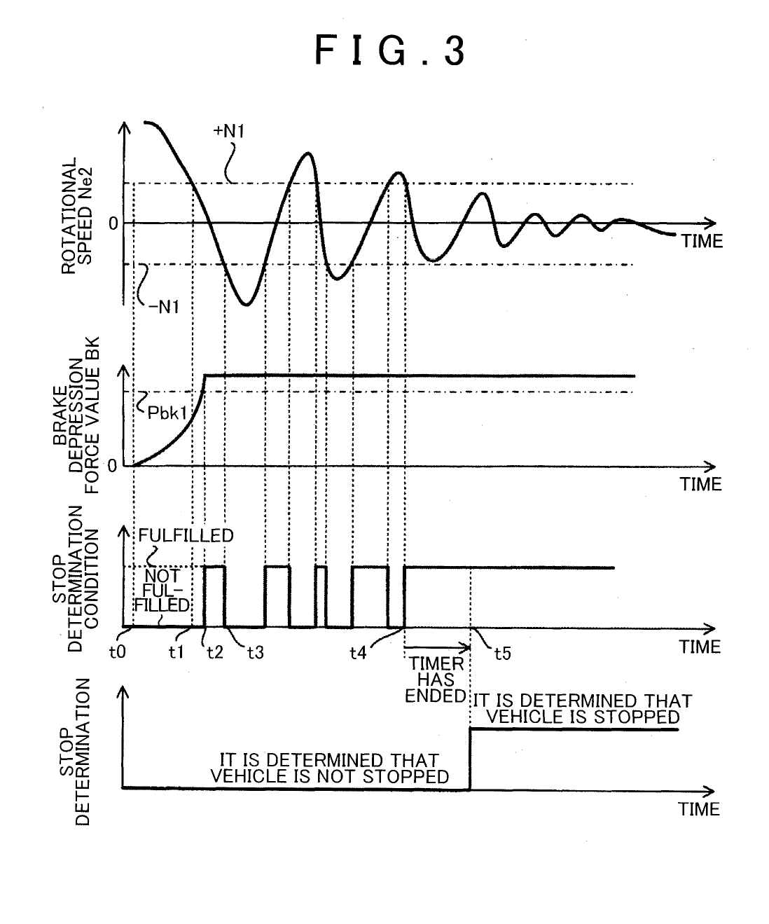

The stop determination unit 172 performs a stop determination operation for determining whether or not the motor-generator MG2 is stopped. The stop determination operation will be described later in detail (with reference to FIGS. 2 and 3), so detailed description thereof is omitted herein.

Incidentally, in consideration of the fact that the drive shaft 15 of the vehicle 1 is coupled to the rotary shaft of the motor-generator MG2, the rotational speed of the drive shaft 15 of the vehicle 1 is synchronized with the rotational speed Ne2 of the rotary shaft of the motor-generator MG2. For example, the rotational speed of the drive shaft 15 of the vehicle 1 is proportional to the rotational speed Ne2 of the rotary shaft of the motor-generator MG2. Accordingly, in the case where the rotational speed Ne2 of the rotary shaft of the motor-generator becomes equal to zero as the motor-generator MG2 is stopped, the rotational speed of the drive shaft 15 ought to become equal to zero as well. The state where the rotational speed of the drive shaft 15 becomes equal to zero is substantially equivalent to a state where the vehicle 1 is stopped. Therefore, stoppage of the motor-generator MG2 can be substantially regarded as corresponding to stoppage of the vehicle 1. The stop determination unit 172 may determine whether or not the vehicle 1 is stopped, in addition to or instead of determining whether or not the motor-generator MG2 is stopped.

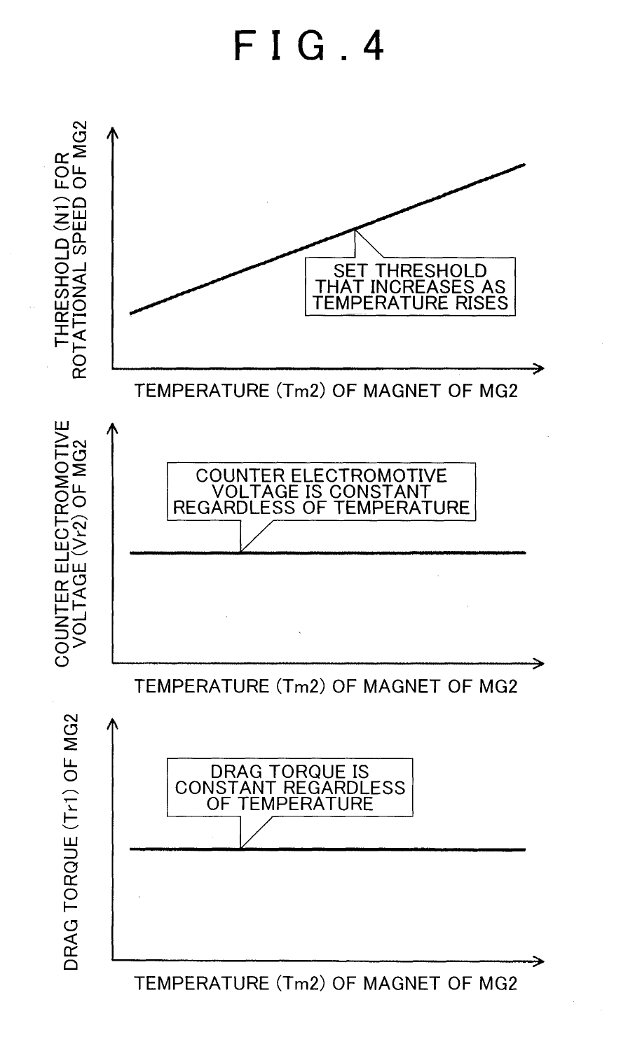

The threshold setting unit 173 sets a threshold used for the stop determination operation, based on the temperature Tm of the motor-generator MG2 detected by the temperature sensor 14b. The threshold setting unit 173 stores, for example, a map showing the value of the threshold corresponding to the temperature Tm of the motor-generator MG2. A concrete method of setting the threshold will be described later (with reference to FIG. 4 and the like), so detailed description thereof is omitted herein. The brake sensor 18 detects a brake depression force value (i.e., a parameter indicating a force with which a foot brake is depressed) BK. The brake sensor 18 preferably outputs the detected brake depression force value BK to the ECU 17.

The electric leakage detector 19 detects electric leakage in an electric system (a so-called motor drive system) that includes the direct-current electric power supply 11, the smoothing capacitor 12, the inverter 13, and the motor-generator MG2.

In order to detect electric leakage, the electric leakage detector 19 is equipped with a coupling capacitor 191, an oscillation circuit 192, a voltage detection circuit 193, and a resistor 194.

A method of detecting electric leakage by the electric leakage detector 19 is as follows. First of all, the oscillation circuit 192 outputs a pulse signal (or an alternating-current signal) with a predetermined frequency. Besides, the voltage detection circuit 193 detects a voltage of a node E that fluctuates as a result of the pulse signal. It should be noted herein that if electric leakage is caused in the electric system, an electric leakage path leading to a chassis ground from the electric system (typically, the electric leakage path is equivalent to a circuit constituted of resistors or a circuit in which resistors and capacitors are connected in parallel) is formed. As a result, the pulse signal output by the oscillation circuit 192 is transmitted through a path leading to the resistor 194, the coupling capacitor 191 and the electric leakage path. Then, the voltage of the pulse signal at the node E is affected by the impedance of the electric leakage path (typically, the resistance value of a resistor included in an equivalent circuit of the electric leakage path). Accordingly, electric leakage can be detected through detection of a voltage of the node E by the voltage detection circuit 193.

(1-2) Flow of Stop Determination Operation in First Embodiment

Subsequently, the flow of a stop determination operation performed in the vehicle 1 according to the first embodiment of the invention (i.e., a stop determination operation performed by the ECU 17) will be described with reference to FIG. 2. FIG. 2 is a flowchart showing the flow of the stop determination operation in the first embodiment of the invention.

As shown in FIG. 2, when the stop determination operation is started, the temperature sensor 14b first detects the temperature Tm2 of the magnet of the motor-generator MG2, and outputs the detected temperature to the ECU 17 (step S100). Then, the threshold setting unit 173 sets thresholds N1 and N2 for the rotational speed Ne2 of the motor-generator MG2 based on the detected temperature Tm2 of the magnet of the motor-generator MG2 (step S101). Incidentally, the threshold N1 is a threshold that is set as part of a condition for starting three-phase short-circuit control in the inverter 13 (i.e., a threshold for determining whether or not the motor-generator MG2 is stopped). The threshold N2 is a threshold that is set as part of a condition for cancelling three-phase short-circuit control in the inverter 13 (i.e., a threshold for determining whether or not the motor-generator MG2 has begun to rotate again). Incidentally, the thresholds N1 and N2 may be set as the same value or different values. A concrete method of setting the thresholds in the threshold setting unit 173 and an effect thereof will be described later in detail.

When the thresholds N1 and N2 are set in the threshold setting unit 173, the stop determination unit 172 determines whether or not a predetermined stop determination condition is fulfilled (step S102).

The stop determination condition includes a stop determination condition based on the rotational speed Ne2 of the motor-generator MG2. In FIG. 2, as an example of the stop determination condition based on the rotational speed Ne2, a condition that the absolute value of the rotational speed Ne2 of the motor-generator MG2 be equal to or smaller than the threshold N1 set in the threshold setting unit 173 (i.e., the relationship: |Ne2|≦N1 be fulfilled) is used.

Furthermore, the stop determination condition includes a stop determination condition based on the presence/absence of an operation capable of stopping the vehicle 1 (which will be referred to hereinafter as “a stop operation” as appropriate). In FIG. 2, as an example of the stop determination condition based on the presence/absence of the stop operation, a condition that the brake depression force value BK be larger than a predetermined threshold Pbks1 (i.e., the relationship: BK>Pbks1 be fulfilled) is used.

Incidentally, the stop operation is typically performed based on the intention of a driver (i.e., a voluntary operation by the driver). However, the stop operation may be automatically performed regardless of the intention of the driver (e.g., automatically under the control by a control unit such as the ECU 17 or the like). A situation where the stop operation is automatically performed can occur in the vehicle 1 in which, for example, automatic driving control (i.e., the control for causing the vehicle 1 to autonomously run regardless of the presence/absence of the operation by the driver) is performed.

The stop determination condition shown in FIG. 2 is nothing more than an example. Accordingly, a stop determination condition different from the stop determination condition shown in FIG. 2 may be used. For example, as long as the state where the vehicle 1 is stopped and the state where the vehicle 1 is not stopped can be distinguished from each other due to the difference in the characteristics of the rotational speed Ne2, an arbitrary condition that utilizes the difference in the characteristics of the rotational speed Ne2 may be used as the stop determination condition based on the rotational speed Ne2. By the same token, as long as the state where the vehicle 1 is stopped and the state where the vehicle 1 is not stopped can be distinguished from each other due to the difference in the characteristics of the stop operation, an arbitrary condition that utilizes the difference in the characteristics of the stop operation may be used as the stop determination condition based on the presence/absence of the stop operation.

Incidentally, the stop determination condition based on the presence/absence of the stop operation is preferably a stop determination condition based on the presence/absence of an operation that directly aims at stopping the vehicle 1. As an example of the operation that directly aims at stopping the vehicle 1, for example, an operation capable of applying a braking force to the vehicle 1 (e.g., an operation for actuating an arbitrary brake such as a foot brake, a handbrake or the like) or an operation that is likely to be performed during stoppage of the vehicle (e.g., an operation for putting a shift lever into a P range or the like) is exemplified. Accordingly, for example, a condition that an arbitrary brake be actuated may be used as the stop determination condition based on the presence/absence of the stop operation. Alternatively, for example, a condition that a braking force resulting from an arbitrary brake be larger than a predetermined threshold (e.g., a condition that the aforementioned brake depression force value BK be larger than the predetermined threshold Pbks1) may be used as the stop determination condition based on the presence/absence of the stop operation. Alternatively, for example, a condition that the range of the shift lever be the P range may be used as the stop determination condition based on the presence/absence of the stop operation.

It should be noted, however, that the stop determination condition based on the presence/absence of the stop operation may be a stop determination condition based on the presence/absence of an operation that does not directly aim at stopping the vehicle 1 but can eventually lead to stoppage of the vehicle 1. As an example of the operation that can lead to stoppage of the vehicle 1, an operation that is likely to be performed prior to stoppage of the vehicle (e.g., an operation for removing a foot from an accelerator pedal) is exemplified. Accordingly, for example, a condition that the accelerator pedal not be operated may be used as the stop determination condition based on the presence/absence of the stop operation.

Alternatively, the stop determination condition based on the presence/absence of the stop operation may be a condition associated with the presence/absence of another operation that occurs as a result of the stop operation. For instance, as an example of another operation that occurs as a result of the stop operation, an operation of setting the torque command value for creep to zero or an operation of setting the torque command value for the motor-generator MG2 to zero is exemplified. Accordingly, for example, a condition that the torque command value for creep be zero or a condition that the torque command value for the motor-generator MG2 be zero may be used as the stop determination condition based on the presence/absence of the stop operation.

If it is determined as a result of the determination in step S102 that the stop determination condition is not fulfilled (step S102: No), the stop determination unit 172 determines that the motor-generator MG2 is not stopped (step S111). Specifically, if it is determined that the absolute value of the rotational speed Ne2 of the motor-generator MG2 is not equal to or smaller than the predetermined threshold N1 (i.e., |Ne2|>N1), the stop determination unit 172 determines that the motor-generator MG2 is not stopped. By the same token, if it is determined that the brake depression force value BK is not larger than the predetermined threshold Pbks1 (i.e., BK≦Pbks1), the stop determination unit 172 determines that the motor-generator MG2 is not stopped.

Incidentally, if it is determined that the motor-generator MG2 is not stopped, the ECU 17 ends the operation. It should be noted, however, that the ECU 17 may perform the operation starting from step S100 again.

On the other hand, if it is determined as a result of the determination in step S102 that the stop determination condition is fulfilled (step S102: Yes), the stop determination unit 172 starts a timer that measures a predetermined period (step S103).

After the timer is started, the stop determination unit 172 determines whether or not a state where the stop determination condition is fulfilled has continued (step S104).

If it is determined as a result of the determination in step S104 that the state where the stop determination condition is fulfilled has not continued (step S104: No), the stop determination unit 172 determines that the motor-generator MG2 is not stopped (step S111). That is, if it is determined that the stop determination condition is not fulfilled before the end of the timer, the stop determination unit 172 determines that the motor-generator MG2 is not stopped. In other words, if it is determined that the state where the stop determination condition is fulfilled has not continued for a predetermined period or more uninterruptedly, the stop determination unit 172 determines that the motor-generator MG2 is not stopped.

On the other hand, if it is determined as a result of the determination in step S104 that the state where the stop determination condition is fulfilled has continued (step S104: Yes), the stop determination unit 172 repeatedly performs the operation of determining whether or not the state where the stop determination condition is fulfilled has continued (step S104) until the timer ends (step S105).

After that, if the timer ends (step S105: Yes), the stop determination unit 172 determines that the motor-generator MG2 is stopped (step S106). That is, if it is determined that the stop determination condition remains fulfilled from the start of the timer to the end of the timer, the stop determination unit 172 determines that the motor-generator MG2 is stopped. In other words, if it is determined that the state where the stop determination condition is fulfilled has continued for the predetermined period or more uninterruptedly, the stop determination unit 172 determines that the motor-generator MG2 is stopped.

Now, the operation of determining whether or not the motor-generator MG2 is stopped will be described using concrete examples of the rotational speed Ne2 and the brake depression force value BK, with reference to FIG. 3. FIG. 3 includes timing charts showing the rotational speed Ne2, the brake depression force value BK, the presence/absence of fulfillment of the stop determination condition, and a result of a determination on stoppage of the vehicle 1.

As shown in FIG. 3, the brake depression force value BK increases in response to the start of the operation of the foot brake at a time point t0. The rotational speed Ne2 also decreases as the brake depression force value BK increases.

Incidentally, when the vehicle 1 attempts to stop as a result of the operation of the foot brake or the like, the drive shaft 15 of the vehicle 1 is likely to be twisted. As a result, as the drive shaft 15 is twisted, the hunting of the rotational speed of the drive shaft 15 becomes likely to occur. In consideration of the fact that the rotary shaft of the motor-generator MG2 is coupled to the drive shaft 15, the hunting of the rotational speed Ne2 of the motor-generator MG2 is also likely to occur. FIG. 3 shows such hunting of the rotational speed Ne2 (upper-limit fluctuations in the rotational speed Ne2 that gradually converges in FIG. 3).

After that, at a time point t1, the absolute value of the rotational speed Ne2 becomes equal to or smaller than the predetermined threshold N1. It should be noted, however, that the brake depression force value BK is not larger than the predetermined threshold Pbk1 at the time point t1. Accordingly, the stop determination condition is not fulfilled.

After that, at a time point t2, the brake depression force value BK becomes larger than the predetermined threshold Pbk1. Therefore, the stop determination condition is fulfilled at the time point t2. It should be noted, however, that the state where the stop determination condition is fulfilled has not continued for the predetermined period or more uninterruptedly at the time point t2, so the stop determination unit 172 does not determine that the motor-generator MG2 is stopped.

After that, due to the influence of hunting, the absolute value of the rotational speed Ne2 exceeds the predetermined threshold N1 at a time point t3 when the predetermined period has not elapsed from the time point t2 (i.e., a time point before the end of the timer started at the time point t2). That is, the stop determination condition is not fulfilled at the time point t3. As a result, the stop determination unit 172 does not determine that the motor-generator MG2 is stopped.

Thereafter, until a time point t4, the absolute value of the rotational speed Ne2 becomes equal to or smaller than the predetermined threshold N1, but the state where the stop determination condition is fulfilled has not continued for the predetermined period or more uninterruptedly. Accordingly, in this case, the stop determination unit 172 does not determine that the motor-generator MG2 is stopped.

After that, at the time point t4, the absolute value of the rotational speed Ne2 becomes equal to or smaller than the predetermined threshold N1 again. Therefore, the stop determination condition is fulfilled at the time point t4. It should be noted, however, that the state where the stop determination condition is fulfilled has not continued for the predetermined period or more uninterruptedly at the time point t4, so the stop determination unit 172 does not determine that the motor-generator MG2 is stopped.

After that, at a time point t5 when the predetermined period has elapsed from the time point t4 (i.e., a time point corresponding to the end of the timer started at the time point t2) as well, the stop determination condition remains fulfilled. Therefore, in the example shown in FIG. 3, the stop determination unit 172 determines, first at the time point t5, that the motor-generator MG2 is stopped.

Returning to FIG. 2, in the first embodiment of the invention, if the stop determination unit 172 determines that the motor-generator MG2 is stopped (step S106: Yes), the inverter control unit 171 controls the operation of the inverter 13 in such a manner as to perform three-phase short-circuit control to fix the state of the motor-generator MG2 to a three-phase short-circuit state (step S107). That is, the inverter control unit 171 controls the operation of the inverter 13 such that all the switching elements of either the upper arms or the lower arms are on and that all the switching elements of the other ones of the upper arms and the lower arms are off. For example, the inverter control unit 171 may control the operation of the inverter 13 such that the p-side switching element Q1, the p-side switching element Q3, and the p-side switching element Q5 are on and that the n-side switching element Q2, the n-side switching element Q4, and the n-side switching element Q6 are off.

It should be noted, however, that the inverter control unit 171 may control the operation of the inverter 13 in such a manner as to perform two-phase short-circuit control to fix the state of the motor-generator MG2 to a two-phase short-circuit state in step S107. That is, the inverter control unit 171 may control the operation of the inverter 13 such that two of the switching elements of either the upper arms or the lower arms are on and that the other one switching element of either the upper arms or the lower arms and all the switching elements of the other ones of the upper arms and the lower arms are off.

Alternatively, in step S107, the inverter control unit 171 may control the operation of the inverter 13 in such a manner as to perform the control of fixing the state of the inverter 13 to a state where only one of the six switching elements included in the inverter 13 is on (on the other hand, the other five switching elements are off).

Furthermore, in the first embodiment of the invention, if it is determined that the motor-generator MG2 is stopped, the electric leakage detector 19 detects electric leakage in the electric system while three-phase short-circuit control is performed (step S107). Incidentally, since at least one of the six switching elements included in the inverter 13 is on, the electric leakage detector 19 can detect electric leakage in an alternating-current region (i.e., a circuit region of the electric system that is located on the motor-generator MG2 side with respect to the inverter 13) as well as electric leakage in a direct-current region (i.e., a circuit region of the electric system that is located on the direct-current electric power supply 11 side with respect to the inverter 13).

In parallel with the operation of step S107, the stop determination unit 172 determines whether or not a predetermined stop cancellation condition is fulfilled (step S108). In the first embodiment of the invention, as is the case with the stop determination condition, the stop cancellation condition includes a stop cancellation condition based on the rotational speed Ne2 of the motor-generator MG2, a stop cancellation condition based on the presence/absence of the stop operation, and a stop cancellation condition based on a determination on the sliding down of the vehicle. In FIG. 2, as an example of the stop cancellation condition based on the rotational speed Ne2, a condition that the absolute value of the rotational speed Ne2 of the motor-generator MG2 be larger than the threshold N2 set in the threshold setting unit 173 (i.e., the relationship: |Ne2|>N2 be fulfilled) is used. By the same token, in FIG. 2, as an example of the stop cancellation condition based on the presence/absence of the stop operation, a condition that the brake depression force value BK be smaller than a predetermined threshold Pbks2 (i.e., the relationship: BK<Pbks2 be fulfilled) is used. Incidentally, the predetermined threshold Pbks2 may be equal to the predetermined threshold Pbks1 or different from the predetermined threshold Pbks1.

Incidentally, the stop cancellation condition shown in FIG. 2 is nothing more than an example. Accordingly, a stop cancellation condition that is different from the stop cancellation condition shown in FIG. 2 may be used. Besides, the stop cancellation condition may be appropriately determined from a standpoint similar to that of the stop determination condition.

The stop determination unit 172 may determine, in step S108, whether or not the corresponding stop determination condition is fulfilled, in addition to or instead of determining whether or not the stop cancellation condition based on the rotational speed Ne2 of the motor-generator MG2 or the stop cancellation condition based on the presence/absence of the stop operation is fulfilled. In this case, if it is determined that the stop determination condition is not fulfilled, the following operation may be performed in the same manner as in the case where it is determined that the stop cancellation condition is fulfilled. On the other hand, if it is determined that the stop determination condition is fulfilled, the following operation may be performed in the same manner as in the case where it is determined that the stop cancellation condition is not fulfilled.

If it is determined as a result of the determination in step S108 that the stop cancellation condition is not fulfilled (step S108: No), the inverter control unit 171 continues to control the operation of the inverter 13 in such a manner as to continue to perform three-phase short-circuit control. By the same token, the electric leakage detector 19 continues to detect electric leakage in the electric system.

On the other hand, if it is determined as a result of the determination in step S108 that the stop cancellation condition is fulfilled (step S108: Yes), the stop determination unit 172 determines that the motor-generator MG2 is not stopped (step S109). In this case, the inverter control unit 171 may control the operation of the inverter 13 in such a manner as to refrain from performing three-phase short-circuit control to fix the state of the motor-generator MG2 to the three-phase short-circuit state (step S110). By the same token, the electric leakage detector 19 ends detection of electric leakage in the electric system (step S110).

After that, the ECU 17 ends the operation. It should be noted, however, that the ECU 17 may perform the operation starting from step S100 again.

As described above, in the first embodiment of the invention, the stop determination unit 172 can determine whether or not the motor-generator MG2 (or the vehicle 1) is stopped, on the basis of both the stop determination condition based on the rotational speed Ne2 of the motor-generator MG2 and the stop determination condition based on the presence/absence of the stop operation. Therefore, the stop determination unit 172 can more accurately determine whether or not the motor-generator MG2 (or the vehicle 1) is stopped than a stop determination unit 172a according to a comparative example that determines, on the basis of only the stop determination condition based on the rotational speed of the engine, whether or not the vehicle 1 is stopped. In addition, the stop determination unit 172 can more accurately determine whether or not the motor-generator MG2 (or the vehicle 1) is stopped than a stop determination unit 172b according to a comparative example that determines, on the basis of only the stop determination condition based on the rotational speed Ne2 of the motor-generator MG2, whether or not the motor-generator MG2 (or the vehicle 1) is stopped. The reason will be described hereinafter.

First of all, the stop determination unit 172a according to the comparative example that determines that the vehicle 1 is stopped if the rotational speed of the engine, instead of the rotational speed Ne2 of the motor-generator MG2, is equal to or lower than a predetermined threshold will be described. The rotational speed of the engine is calculated from a crank angle of the engine instead of being detected by a detection mechanism that directly detects the rotational speed. The crank angle of the engine is output from a crank angle sensor that is installed in the engine. However, the accuracy of the rotational speed of the engine calculated from the crank angle is often lower than the accuracy of the rotational speed Ne2 of the motor-generator MG2 detected by the rotational angle sensor 14 (i.e., a detection mechanism that directly detects the rotational speed Ne2 of the motor-generator MG2). Therefore, the stop determination unit 172a according to the comparative example may erroneously determine that the vehicle 1 is stopped although the vehicle 1 is not stopped, as a result of an error or the like in the accuracy of the rotational speed of the engine calculated from the crank angle. Alternatively, the stop determination unit 172a according to the comparative example may erroneously determine that the vehicle 1 is not stopped although the vehicle 1 is stopped.

Hence, the stop determination unit 172 according to the first embodiment of the invention can determine, based on the rotational speed Ne2 of the motor-generator MG2 detected by the rotational angle sensor 14, whether or not the motor-generator MG2 (or the vehicle 1) is stopped. In consideration of the fact that the accuracy of the rotational speed Ne2 of the motor-generator MG2 detected by the rotational angle sensor 14 is often higher than the accuracy of the rotational speed of the engine calculated from the crank angle, the stop determination unit 172 according to the first embodiment of the invention can more accurately determine whether or not the motor-generator MG2 (or the vehicle 1) is stopped than the stop determination unit 172a according to the comparative example.

Furthermore, the stop determination unit 172b according to the comparative example that determines that the motor-generator MG2 (or the vehicle 1) is stopped if the rotational speed Ne2 of the motor-generator MG2 is equal to or lower than the predetermined threshold N1, without determining whether or not the stop operation is performed, will be described. The stop determination unit 172b according to this comparative example is also considered to be capable of more accurately determining whether or not the vehicle 1 is stopped than the stop determination unit 172a according to the aforementioned comparative example. However, the rotational speed Ne2 of the motor-generator MG2 detected by the rotational angle sensor 14 may sway (i.e., may fluctuate) due to the influence of noise and the like generated in the rotational angle sensor 14. For example, although the actual rotational speed of the motor-generator MG2 is zero, the rotational speed Ne2 of the motor-generator MG2 detected by the rotational angle sensor 14 may assume a value other than zero. Accordingly, in some cases, the stop determination unit 172b according to the comparative example may erroneously determine that the motor-generator MG2 (or the vehicle 1) is stopped although the motor-generator MG2 (or the vehicle 1) is not stopped. Alternatively, in some cases, the stop determination unit 172b according to the comparative example may erroneously determine that the motor-generator MG2 (or the vehicle 1) is not stopped although the motor-generator MG2 (or the vehicle 1) is stopped.

Consequently, the stop determination unit 172 according to the first embodiment of the invention can determine, based on the presence/absence of the stop operation as well as the rotational speed Ne2 of the motor-generator MG2, whether or not the motor-generator MG2 (or the vehicle 1) is stopped. It should be noted herein that the possibility of the motor-generator MG2 (or the vehicle 1) being stopped is much higher when the stop operation is performed. Therefore, the stop determination unit 172 according to the first embodiment of the invention can more accurately determine whether or not the motor-generator MG2 (or the vehicle 1) is stopped than the stop determination unit 172b according to the comparative example.

In addition, the stop determination unit 172 can determine that the motor-generator MG2 (or the vehicle 1) is stopped if it is determined that the state where the stop determination condition is fulfilled has continued for the predetermined period or more uninterruptedly. Accordingly, the stop determination unit 172 can more accurately determine whether or not the motor-generator MG2 (or the vehicle 1) is stopped, even in the case where the hunting of the rotational speed Ne2 of the motor-generator MG2 occurs (or the rotational speed Ne2 of the motor-generator MG2 fluctuates).

Specifically, when the hunting of the rotational speed of the motor-generator MG2 occurs, the state where the rotational speed Ne2 is equal to or lower than the predetermined threshold N1 and the state where the rotational speed Ne2 is not equal to or lower than the predetermined threshold N1 alternately arise within a short time. If it is determined under such a circumstance that the motor-generator MG2 (or the vehicle 1) is stopped when the rotational speed Ne2 is simply equal to or lower than the predetermined threshold N1, the result of the determination as to whether or not the motor-generator MG2 (or the vehicle 1) is stopped is likely to fluctuate frequently.

Thus, in the first embodiment of the invention, the stop determination unit 172 can determine that the motor-generator MG2 (or the vehicle 1) is not stopped if it is determined that the rotational speed Ne2 is equal to or lower than the predetermined threshold N1 only for a short time as a result of hunting or the like. On the other hand, the stop determination unit 172 can determine that the motor-generator MG2 (or the vehicle 1) is stopped if it is determined that the rotational speed Ne2 has continued to be equal to or lower than the predetermined threshold N1 for a certain long time or more as a result of the convergence of hunting or the like. Accordingly, the stop determination unit 172 can favorably determine whether or not the motor-generator MG2 (or the vehicle 1) is stopped, while restraining the result of the determination as to whether or not the motor-generator MG2 (or the vehicle 1) is stopped from frequently fluctuating as a result of the influence of hunting or the like.

In addition, the inverter control unit 171 according to the first embodiment of the invention controls the inverter 13 in such a manner as to perform three-phase short-circuit control while it is determined that the motor-generator MG2 (or the vehicle 1) is stopped.

It should be noted herein that while three-phase short-circuit control is performed, it may be impossible to supply an electric power that is needed to output a torque required for the running of the vehicle 1 from the inverter 13 to the motor-generator MG2. Accordingly, the inverter control unit 171 preferably controls the inverter 13 in such a manner as to perform three-phase short-circuit control while the motor-generator MG2 (or the vehicle 1) is stopped. Conversely, if three-phase short-circuit control is performed while the motor-generator MG2 (or the vehicle 1) is not stopped, the running of the vehicle 1 may be affected. Accordingly, the inverter control unit 171 preferably controls the inverter 13 in such a manner as to refrain from performing three-phase short-circuit control while the motor-generator MG2 (or the vehicle 1) is not stopped. Then, in the first embodiment of the invention, as described above, the stop determination unit 172 can accurately determine whether or not the motor-generator MG2 (or the vehicle 1) is stopped, so the inverter control unit 171 can control the inverter 13 in such a manner as to perform three-phase short-circuit control exactly while the motor-generator MG2 (or the vehicle 1) is stopped. That is, the inverter control unit 171 can control the inverter 13 in such a manner as to perform three-phase short-circuit control at a timing when the running of the vehicle 1 is not affected.

Besides, when a drag torque Tr2 is generated in the motor-generator MG2 while three-phase short-circuit control of the inverter 13 is performed, a deterioration in drivability may be caused due to vibration and the like of the vehicle 1. This drag torque Tr2 changes depending on a counter electromotive voltage Vr2 of the motor-generator MG2 (specifically, the drag torque Tr2 of the motor-generator MG2 increases as the counter electromotive voltage Vr2 increases). Besides, the counter electromotive voltage Vr2 of the motor-generator MG2 changes depending on a temperature Tm2 of a magnet of the motor-generator MG2 (specifically, the counter electromotive voltage Vr2 of the motor-generator MG2 drops as the magnet temperature Tm2 rises). Therefore, if the thresholds N1 and N2 as conditions for starting and cancelling three-phase short-circuit control are assumed to be constant values, inconveniences as mentioned above may be caused.

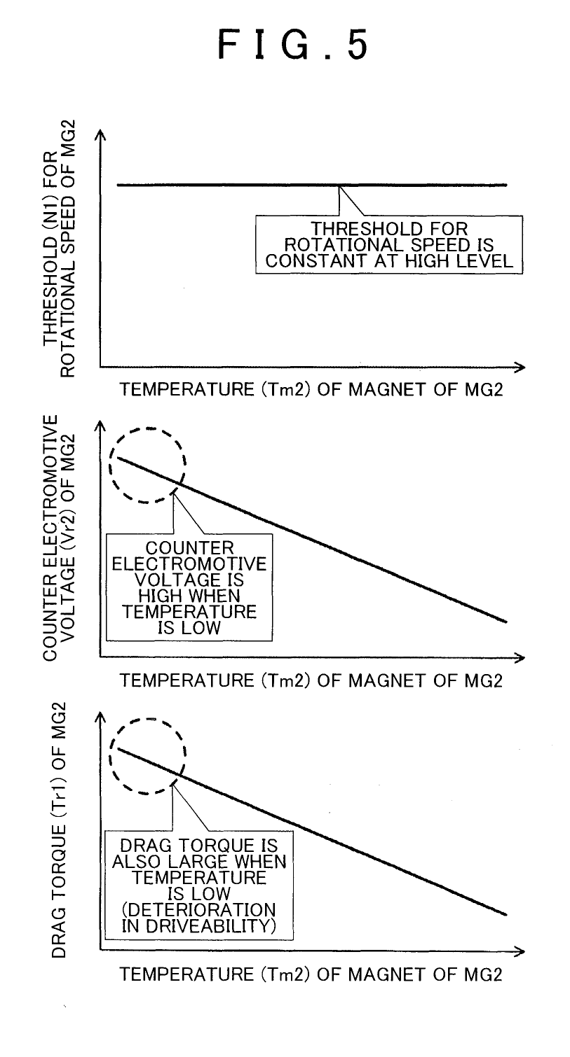

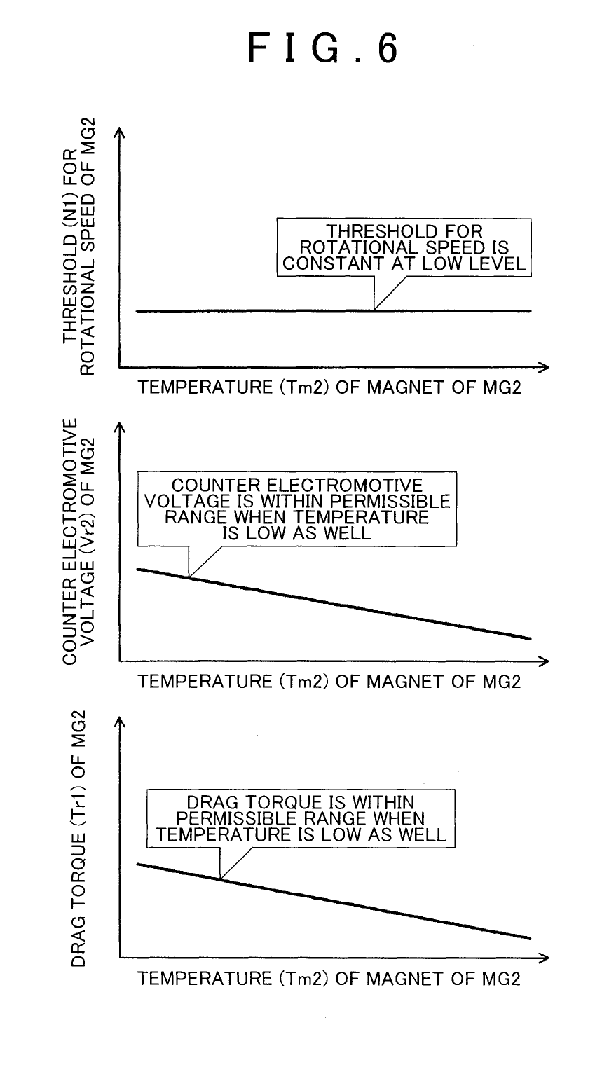

Hereinafter, an effect of the first embodiment of the invention (see FIG. 4) in which the thresholds N1 and N2 can be appropriately changed in accordance with the temperature Tm2 of the motor-generator MG2 will be described while making a comparison with a first comparative example (see FIG. 5) in which inconveniences may be caused and a modification example (see FIG. 6) in which an effect different from that of the first embodiment of the invention can be exerted. It should be noted herein that FIG. 4 includes graphs showing a method of setting the thresholds in the first embodiment of the invention, in conjunction with the counter electromotive voltage and the drag torque of the motor-generator MG2 during three-phase short-circuit control. Besides, FIG. 5 includes graphs showing a method of setting the thresholds in the first comparative example, in conjunction with the counter electromotive voltage and the drag torque of the motor-generator MG2 during three-phase short-circuit control. FIG. 6 includes graphs showing a method of setting the thresholds in the modification example, in conjunction with the counter electromotive voltage and the drag torque of the motor-generator MG2 during three-phase short-circuit control.

As shown in FIG. 4, the threshold setting unit 173 according to the first embodiment of the invention sets the threshold N1 to a value that increases as the temperature Tm2 of the magnet of the motor-generator MG2 rises. If the threshold N1 is thus set, the counter electromotive voltage Vr2 of the motor-generator MG2 during three-phase short-circuit control can be made constant regardless of the magnet temperature Tm2. Besides, the drag torque Tr2 of the motor-generator MG2 during three-phase short-circuit control can be made constant regardless of the magnet temperature Tm2.

On the other hand, with the threshold setting unit 173a according to the first comparative example shown in FIG. 5, the threshold N1 is made constant at a high level (e.g., a value equivalent to the threshold N1 in the case where the magnet temperature Tm2 in the first embodiment of the invention is relatively high) regardless of the temperature Tm2 of the magnet of the motor-generator MG2. In this case, the counter electromotive voltage Vr2 of the motor-generator MG2 during three-phase short-circuit control rises as the temperature Tm2 of the magnet of the motor-generator MG2 drops. By the same token, the drag torque Tr2 of the motor-generator MG2 during three-phase short-circuit control increases as the temperature Tm2 of the magnet of the motor-generator MG2 drops. As a result, when the magnet temperature Tm2 is low, a deterioration in drivability may be caused by the drag torque.

In contrast with this first comparative example, according to the threshold setting unit 173 of the first embodiment of the invention, the threshold N1 is changed in accordance with the temperature Tm2 of the magnet of the motor-generator MG2, and the counter electromotive voltage Vr2 and the drag torque Tr2 of the motor-generator MG2 during three-phase short-circuit control are made constant. Accordingly, a deterioration in drivability can be prevented when the magnet temperature Tm2 is low.

Besides, with a threshold setting unit 173b according to the modification example shown in FIG. 6, the threshold N1 is made constant at a low level (e.g., a value equivalent to the threshold N1 in the case where the magnet temperature Tm2 in the first embodiment of the invention is relatively low) regardless of the temperature Tm2 of the magnet of the motor-generator MG2. In this case, the counter electromotive voltage Vr2 of the motor-generator MG2 during three-phase short-circuit control rises as the temperature Tm2 of the magnet of the motor-generator MG2 drops, but does not become as high as in the first comparative example. By the same token, the drag torque Tr2 of the motor-generator MG2 during three-phase short-circuit control increases as the temperature Tm2 of the magnet of the motor-generator MG2 drops, but does not become as large as in the first comparative example. In consequence, the modification example makes it possible to prevent a deterioration in drivability that can occur in the first comparative example. Besides, in a region where the magnet temperature Tm2 is relatively high, the counter electromotive voltage Vr2 of the motor-generator MG2 is still lower, and the drag torque Tr2 of the motor-generator MG2 is still smaller. In consequence, if only the magnitudes of the counter electromotive voltage Vr2 of the motor-generator MG2 and the drag torque Tr2 of the motor-generator MG2 are simply observed, it is possible to conclude that the modification example is more advantageous than the first embodiment of the invention.

It should be noted, however, that in the modification example, since the threshold N1 is fixed to the low level, three-phase short-circuit control is unlikely to be performed when the temperature Tm2 of the magnet of the motor-generator MG2 is relatively high. That is, even in the case where the drag torque upon the start of three-phase short-circuit control is not considered to become large, the performance of three-phase short-circuit control is greatly limited. As a result, the effect of improving fuel economy through the performance of three-phase short-circuit control deteriorates. In consequence, as far as the effect of improving fuel economy is concerned, it is possible to conclude that the first embodiment of the invention is more advantageous than the modification example.

As a result of the foregoing, the first embodiment of the invention or the modification example may be appropriately selected depending on whether higher priority is given to a drop in the counter electromotive voltage Vr2 of the motor-generator MG2 and a decrease in the drag torque Tr2 of the motor-generator MG2 or to the effect of improving fuel economy.

Incidentally, only the threshold N1 as the condition for starting three-phase short-circuit control has been described herein, but a similar effect is exerted by changing the threshold N2 as the condition for cancelling three-phase short-circuit control in accordance with the temperature Tm2 of the magnet of the motor-generator MG2.

Besides, the electric leakage detector 19 according to the first embodiment of the invention can detect electric leakage while it is determined that the motor-generator MG2 (or the vehicle 1) is stopped (in other words, while the inverter 13 is controlled in such a manner as to perform three-phase short-circuit control). It should be noted herein that if the state of the inverter 13 fluctuates while the electric leakage detector 19 detects electric leakage, the state in the electric system (e.g., the impedance of a path including the aforementioned electric leakage path) may fluctuate as a result of fluctuations in the state of the inverter 13. As a result, the electric leakage detector 19 may erroneously recognize state fluctuations resulting from fluctuations in the state of the inverter 13 (e.g., fluctuations in the voltage of the aforementioned node E) as state fluctuations resulting from electric leakage. Accordingly, from the standpoint of enhancing the accuracy in detecting electric leakage by the electric leakage detector 19, the state of the inverter 13 is preferably fixed to a three-phase short-circuit state (or other states including a two-phase short-circuit state) while the electric leakage detector 19 detects electric leakage.

It should be noted herein that when the accuracy in determining whether or not the motor-generator MG2 (or the vehicle 1) is stopped is relatively low, the result of the determination as to whether or not the motor-generator MG2 (or the vehicle 1) is stopped is more likely to fluctuate frequently as a result of the aforementioned noise, hunting and the like, than in the case where the determination accuracy is relatively high. Consequently, the state of the inverter 13 is also likely to fluctuate frequently as a result of fluctuations in the result of the determination as to whether or not the motor-generator MG2 (or the vehicle 1) is stopped. As a result, the period in which the state of the inverter 13 remains fixed to the three-phase short-circuit state may become shorter than the period needed for detection of electric leakage by the electric leakage detector 19.

For this reason, if it is accurately determined whether or not the motor-generator MG2 (or the vehicle 1) is stopped, the state of the inverter 13 is likely to remain fixed to the three-phase short-circuit state. Then, in the first embodiment of the invention, as described above, the stop determination unit 172 can accurately determine whether or not the motor-generator MG2 (or the vehicle 1) is stopped. Therefore, the state of the inverter 13 is relatively likely to be fixed (typically to remain fixed to the three-phase short-circuit state (or other states including the two-phase short-circuit state)) while the electric leakage detector 19 detects electric leakage. Accordingly, the electric leakage detector 19 can favorably detect electric leakage.

Incidentally, in the foregoing description, the vehicle 1 is equipped, with the single motor-generator MG2. However, the vehicle 1 may be equipped with a plurality of motor-generators MG2. In this case, the vehicle 1 is preferably equipped with the inverter 13 and the rotational angle sensor 14 for each of the motor-generators MG2. Besides, in this case, the ECU 17 may perform the aforementioned stop determination operation independently for each of the motor-generators MG2.

### (2) Second Embodiment

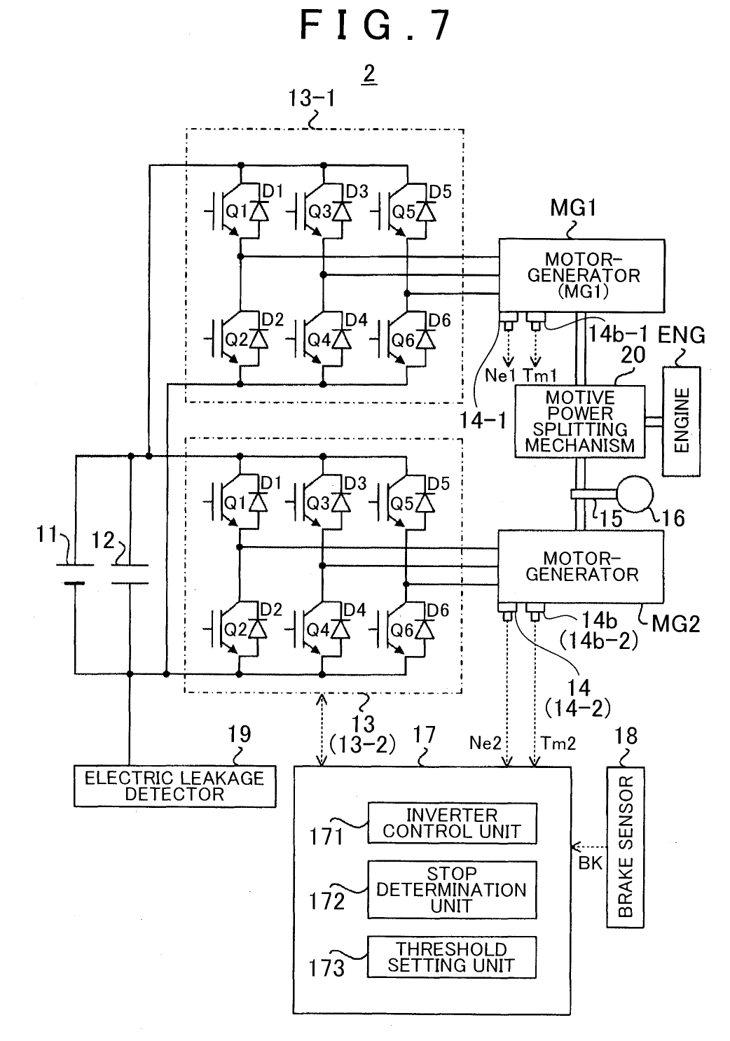

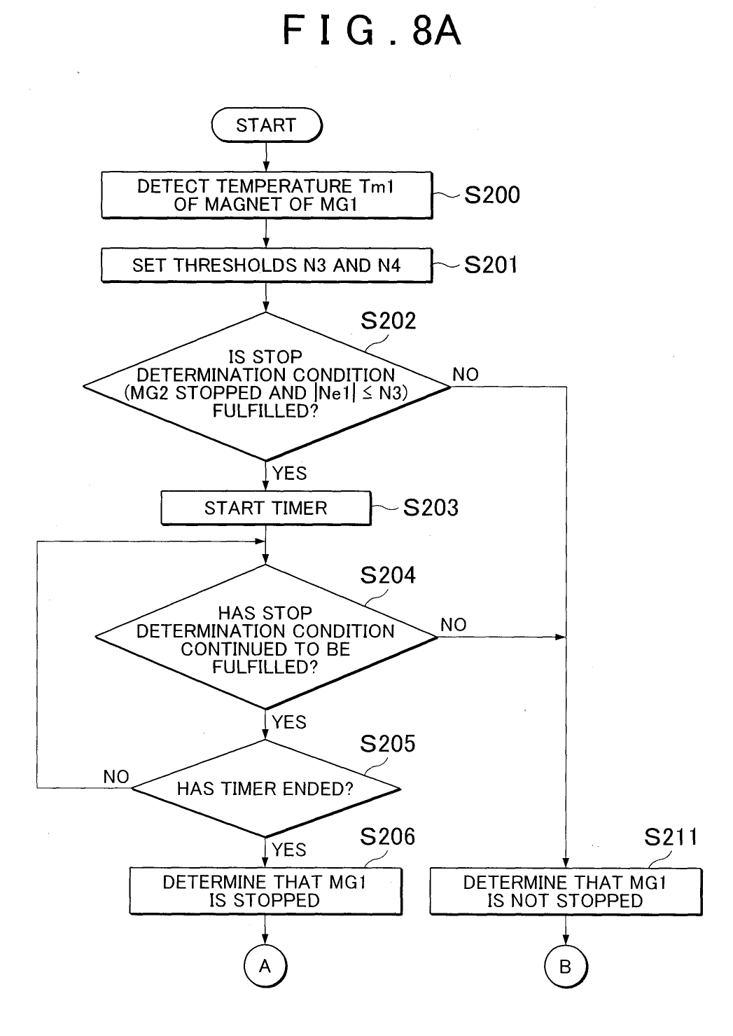

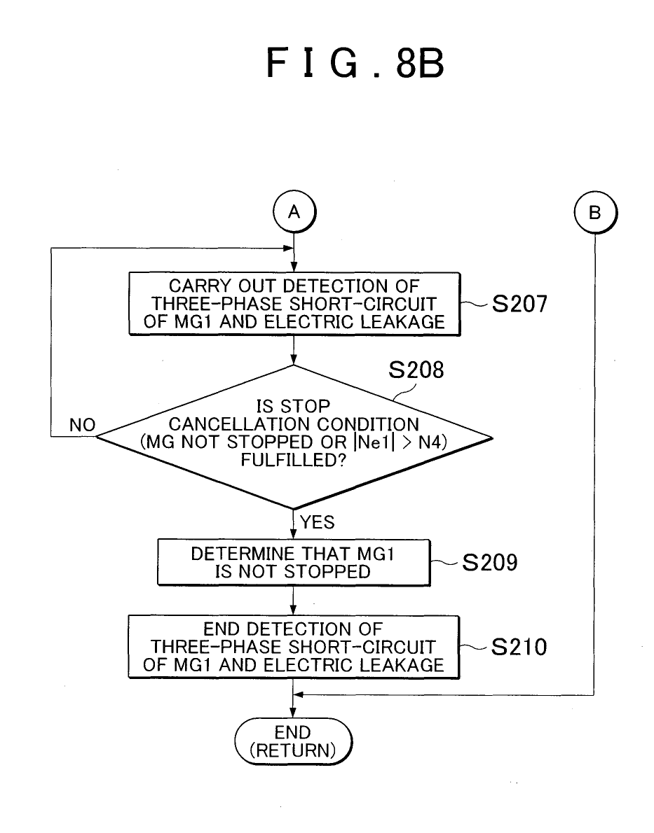

Next, the second embodiment of the invention will be described with reference to FIGS. 7 and 8. Incidentally, the second embodiment of the invention is different from the aforementioned first embodiment of the invention only in part of configuration and operation, and is substantially identical thereto in other details. Therefore, hereinafter, what is different from the first embodiment of the invention will be described in detail, and what is the same as the first embodiment of the invention will be omitted as appropriate.

(2-1) Configuration of Vehicle According to Second Embodiment

In particular, the second embodiment of the invention is different from the first embodiment of the invention in the configuration of a power engine. In consequence, first of all, the configuration of a vehicle 2 according to the second embodiment of the invention will be described with reference to FIG. 7. FIG. 7 is a block diagram showing the configuration of the vehicle according to the second embodiment of the invention.

As shown in FIG. 7, the vehicle 2 according to the second embodiment of the invention is different from the vehicle 1 according to the first embodiment of the invention shown in FIG. 1 in being further equipped with an engine ENG, a motor-generator MG1, an inverter 13-1, a rotational angle sensor 14-1, a temperature sensor 14b-2, and a motive power splitting mechanism 20. The other components of the vehicle 2 according to the second embodiment of the invention are identical to the other components of the vehicle 1 according to the first embodiment of the invention. It should be noted, however, that the inverter 13 of the first embodiment of the invention will be referred to as an inverter 13-2, and the rotational angle sensor 14 of the first embodiment of the invention will be referred to as a rotational angle sensor 14-2 in the second embodiment of the invention, for the convenience of explanation. Besides, for the sake of simplification of the drawing, the detailed configuration of the electric leakage detector 19 is omitted in FIG. 7. However, it goes without saying that the electric leakage detector 19 of the second embodiment of the invention is identical to the electric leakage detector 19 of the first embodiment of the invention.

The inverter 13-1 is connected in parallel to the inverter 13-2. The inverter 13-1 converts an alternating-current electric power (a three-phase alternating-current voltage) generated through regenerative electric power generation by the motor-generator MG1 into a direct-current electric power (a direct-current voltage). As a result, the direct-current electric power supply 11 is charged with the direct-current electric power (the direct-current voltage) generated as a result of a conversion operation by the inverter 13-1. Incidentally, since the configuration of the inverter 13-1 is identical to the configuration of the inverter 13-2, the detailed description of the configuration of the inverter 13-1 will be omitted.

The motor-generator MG1 is a three-phase alternating-current electric power generator. The motor-generator MG1 regenerates an electric power (generates an electric power) during braking of the vehicle 1. It should be noted, however, that the motor-generator MG1 may be driven in such a manner as to generate a torque needed for the running of the vehicle 2.

The rotational angle sensor 14-1 detects a rotational speed of the motor-generator MG1 (i.e., a rotational speed of the rotary shaft of the motor-generator MG1) Ne1. Incidentally, the rotational angle sensor 14-1 may be identical to the rotational angle sensor 14-2.

The temperature sensor 14b-1 detects a temperature Tm1 of a magnet of the motor-generator MG1. Incidentally, the temperature sensor 14b-1 may be identical to the temperature sensor 14b-2.

The engine ENG is an internal combustion engine such as a gasoline engine or the like, and functions as a main motive power source of the vehicle 2.

The motive power splitting mechanism 20 is a planetary gear mechanism that is equipped with a sun gear (not shown), a planetary carrier (not shown), a pinion gear (not shown), and a ring gear (not shown). The motive power splitting mechanism 20 mainly splits the motive power of the engine ENG into two systems (i.e., the system of the motive power transmitted to the motor-generator MG1 and the system of the motive power transmitted to the drive shaft 15).

Incidentally, in the second embodiment of the invention, an example in which the vehicle 2 adopts a so-called split (motive power splitting)-type hybrid system (e.g., Toyota Hybrid System: THS) is described. However, the vehicle 2 may adopt a series-type hybrid system or a parallel-type hybrid system.

(2-2) Flow of Stop Determination Operation in Second Embodiment

Subsequently, the flow of a stop determination operation that is performed in the vehicle 2 according to the second embodiment of the invention (i.e., a stop determination operation performed by the ECU 17) will be described with reference to FIG. 8. FIG. 8 is a flowchart showing the flow of the stop determination operation in the second embodiment of the invention.

A series of processes shown in FIG. 8 are operations for determining whether or not the motor-generator MG1 is stopped, and are operations that are performed in parallel with or before or after the stop determination operation of the aforementioned first embodiment of the invention.

When the stop determination operation is started, the temperature sensor 14b-1 first detects the temperature Tm1 of the magnet of the motor-generator MG1, and outputs the detected temperature to the ECU 17 (step S200). Then, the threshold setting unit 173 sets thresholds N3 and N4 for a rotational speed Ne1 of the motor-generator MG1 based on the detected temperature Tm1 of the magnet of the motor-generator MG1 (step S201). Incidentally, the threshold N3 is a threshold that is set as part of the condition for starting three-phase short-circuit control in the inverter 13-1 (i.e., a threshold for determining whether or not the motor-generator MG1 is stopped), and the threshold N4 is a threshold that is set as part of the condition for cancelling three-phase short-circuit control in the inverter 13-1 (i.e., a threshold for determining whether or not the motor-generator MG1 has begun to rotate again). Incidentally, the thresholds N3 and N4 may be set as the same value or different values.

When the thresholds N3 and N4 are set in the threshold setting unit 173, the stop determination unit 172 determines whether or not a predetermined stop determination condition is fulfilled (step S202).

The stop determination condition according to the second embodiment of the invention includes a stop determination condition based on a result of the stop determination operation according to the first embodiment of the invention (i.e., a result of the determination as to whether or not the motor-generator MG2 is stopped). In FIG. 8, as an example of the stop determination condition based on the result of the stop determination operation according to the first embodiment of the invention, a condition that it be determined that the motor-generator MG2 (or the vehicle 1) is stopped through the stop determination operation according to the first embodiment of the invention is used.

Furthermore, the stop determination condition according to the second embodiment of the invention includes a stop determination condition based on the rotational speed Ne1 of the motor-generator MG1. In FIG. 8, as an example of the stop determination condition based on the rotational speed Ne1, a condition that the absolute value of the rotational speed Ne1 of the motor-generator MG1 be equal to or smaller than the threshold N3 set in the threshold setting unit 173 (i.e., the relationship: |Ne1|≦N3 be fulfilled) is used. Incidentally, the stop determination condition shown in FIG. 8 is nothing more than an example, and may be appropriately changed from a standpoint similar to that of the first embodiment of the invention.

If it is determined as a result of the determination in step S202 that the stop determination condition is not fulfilled (step S202: No), the stop determination unit 172 determines that the motor-generator MG1 is not stopped (step S211).

On the other hand, if it is determined as a result of the determination in step S202 that the stop determination condition is fulfilled (step S202: Yes), the stop determination unit 172 determines whether or not a state where the stop determination condition is fulfilled has continued for a predetermined time or more uninterruptedly (from step S203 to step S205) as is the case with the first embodiment of the invention.

If it is determined as a result of the determinations in step S204 and step S205 that the state where the stop determination condition is fulfilled has not continued for the predetermined time or more uninterruptedly (step S204: No), the stop determination unit 172 determines that the motor-generator MG1 is not stopped (step S211).

On the other hand, if it is determined as a result of the determinations in step S204 and step S205 that the state where the stop determination condition is fulfilled has continued for the predetermined time or more uninterruptedly (step S204: Yes and step S205: Yes), the stop determination unit 172 determines that the motor-generator MG1 is stopped (step S206). This is because when the rotational speed Ne1 of the motor-generator MG1 is relatively low (e.g., several rpm to several dozens of rpm) under a circumstance where the motor-generator MG2 is stopped, the rotational speed of the engine ENG also ought to be relatively low (e.g., about several rpm) as is apparent from an operation collinear diagram of the motor-generators MG1 and MG2 and the engine ENG. However, in consideration of the fact that the rotational speed of the engine ENG can hardly become several rpm due to the specification of the engine ENG, the rotational speed of the engine ENG is estimated to be substantially zero when the rotational speed Ne1 of the motor-generator MG1 is relatively low under a circumstance where the motor-generator MG2 is stopped. That is, the engine ENG is estimated to be stopped when the rotational speed Ne1 of the motor-generator MG1 is relatively low under a circumstance where the motor-generator MG2 is stopped. As a result, it is estimated from the operation collinear diagram that the motor-generator MG1 is also substantially stopped.

After that, if it is determined that the motor-generator MG1 is stopped, the ECU 17 (or other components such as the electric leakage detector 19 and the like) may perform an operation that should be performed while the motor-generator MG1 is stopped. In a first operation example, if it is determined that the motor-generator MG1 is stopped, the inverter control unit 171 controls the operation of the inverter 13-1 in such a manner as to perform three-phase short-circuit control to hold the state of the motor-generator MG1 fixed to the three-phase short-circuit state (step S207). It should be noted, however, that the operation of the inverter 13-1 may be controlled in such a manner as to perform the control of holding the state of the motor-generator MG1 fixed to a state other than the three-phase short-circuit state in the second embodiment of the invention as well as the first embodiment of the invention. In addition, if it is determined that the motor-generator MG1 is stopped, the electric leakage detector 19 detects electric leakage in the electric system while three-phase short-circuit control is performed (step S207).

Incidentally, in the second embodiment of the invention, there may arise a situation where it is determined that the motor-generator MG1 is not stopped while the motor-generator MG2 is stopped. In this case, the state of the inverter 13-1 may not be fixed, so the electric leakage detector 19 may refrain from detecting electric leakage in the electric system.

In parallel with the operation of step S207, the stop determination unit 172 determines whether or not a predetermined stop cancellation condition is fulfilled (step S208). In the second embodiment of the invention, the stop cancellation condition includes both a stop cancellation condition based on the result of the stop determination operation according to the first embodiment of the invention and a stop cancellation condition based on the rotational speed Ne1 of the motor-generator MG1, as is the case with the stop determination condition. In FIG. 8, as an example of the stop cancellation condition based on the result of the stop determination operation according to the first embodiment of the invention, a condition that it be determined that the motor-generator MG2 (or the vehicle 1) is not stopped through the stop determination operation according to the first embodiment of the invention is used. Besides, in FIG. 8, as an example of the stop cancellation condition based on the rotational speed Ne1, a condition that the absolute value of the rotational speed Ne1 of the motor-generator MG1 be larger than the threshold N4 set in the threshold setting unit 173 (i.e., the relationship: |Ne1|>N4 be fulfilled) is used. Incidentally, the stop cancellation condition shown in FIG. 8 is nothing more than an example, and may be appropriately changed from a standpoint similar to that of the first embodiment of the invention.

If it is determined as a result of the determination in step S208 that the stop cancellation condition is not fulfilled (step S208: No), the inverter control unit 171 continues to control the operation of the inverter 13-1 in such a manner as to continue to perform three-phase short-circuit control. By the same token, the electric leakage detector 19 continues to detect electric leakage in the electric system.

On the other hand, if it is determined as a result of the determination in step S208 that the stop cancellation condition is fulfilled (step S208: Yes), the stop determination unit 172 determines that the motor-generator MG1 is not stopped (step S209). In this case, the inverter control unit 171 may control the operation of the inverter 13-1 in such a manner as to refrain from performing three-phase short-circuit control to hold the state of the motor-generator MG1 fixed to the three-phase short-circuit state (step S210). By the same token, the electric leakage detector 19 ends detection of electric leakage in the electric system (step S210).

As described above, in the second embodiment of the invention as well, effects similar to various effects enjoyed in the first embodiment of the invention are favorably enjoyed. Incidentally, since the vehicle 2 according to the second embodiment of the invention is equipped with the engine ENG, a parameter such as the rotational speed of the engine ENG or the like can also be utilized as the stop determination condition. Besides, in the second embodiment of the invention, the case where the stop determination operations for the motor-generator MG1 and the motor-generator MG2 are separately performed has been described. However, if a determination is made by simultaneously utilizing the thresholds N3 and N4 corresponding to the motor-generator MG1 and the thresholds N1 and N2 corresponding to the motor-generator MG2, the stop determination operations for the motor-generator MG1 and the motor-generator MG2 can be comprehensively performed as well.

The invention is not limited to the aforementioned embodiments thereof, but can be appropriately altered without departing from the gist or concept of the invention readable from the claims and the entire specification. A control device for a vehicle subjected to such alterations is also encompassed in the technical scope of the invention.

1. A control device for a vehicle, the vehicle including
a three-phase alternating-current electric motor that is driven at a rotational speed synchronized with a rotational speed of a drive shaft of the vehicle, the three-phase alternating-current electric motor being provided with first switching elements and second switching elements in three phases of the three-phase alternating-current electric motor respectively, and the first switching elements and the second switching elements being connected in series to each other respectively; and
an electric power converter that converts an electric power supplied to the three-phase alternating-current electric motor from a direct-current electric power into an alternating-current electric power, the control device comprising:
an electronic control unit configured to
a) determine whether or not a rotational speed of the three-phase alternating-current electric motor is equal to or lower than a predetermined rotational speed,
b) determine whether or not a stop operation to stop the vehicle is performed,
c) determine that the vehicle is stopped, when the electronic control unit determines that the rotational speed of the three-phase alternating-current electric motor is equal to or lower than the predetermined rotational speed and the stop operation is performed,
d) control the electric power converter such that a state of the electric power converter becomes a specific state when the electronic control unit determines that the vehicle is stopped, the specific state being a state where i) all the first switching are off and at least one of the second switching elements is on or ii) all the second switching elements are off and at least one of the first elements is on, and
e) set the predetermined rotational speed based on a temperature of a magnet of the three-phase alternating-current electric motor.

2. The control device according to claim 1, wherein
the electronic control unit is configured to set the predetermined rotational speed such that the predetermined rotational speed increases as the temperature of the magnet of the three-phase alternating-current electric motor rises.

3. The control device according to claim 1, wherein
the electronic control unit is configured to set the predetermined rotational speed such that a drag torque in the three-phase alternating-current electric motor becomes equal to or smaller than a predetermined value regardless of the temperature of the magnet of the three-phase alternating-current electric motor.

4. The control device according to claim 1, wherein
the electronic control unit is configured to set the predetermined rotational speed such that a counter electromotive voltage in the three-phase alternating-current electric motor becomes equal to or lower than a predetermined value regardless of the temperature of the magnet of the three-phase alternating-current electric motor.
